(19) United States
(12) Patent Application Publication
(10) Pub. No.: US 2009/0091130 A1
(43) Pub. Date: Apr. 9, 2009

(54) Method and apparatus of preventing gas leak in pipeline

(76) Inventors: Sheng-Long Lee, Jhongli City (TW); Jing-Chie Lin, Jhongli City (TW); Che-Wei Hsu, Jhongli City (TW); Yu-Chou Tsai, Jhongli City (TW); Fu-Kai Hsu, Jhongli City (TW)

Correspondence Address: HDLS Patent & Trademark Services, P.O. BOX 220746, CHANTILLY, VA, 20153-0746, US

(21) Appl. No.: 11/923,769

(22) Filed: Oct. 25, 2007

(30) Foreign Application Priority Data
Oct. 5, 2007 (TW) 096137558

(51) Int. Cl. F16J 15/02

(52) U.S. Cl. 285/335; 48/194

(57) ABSTRACT

This invention discloses a method and an apparatus of preventing a gas leak in a pipeline, and the characteristic of expansion occurred when a hydrogen storage material absorbs hydrogen gas is used for setting the hydrogen storage material in a joint between a first pipeline and a second pipeline, such that if hydrogen leaks at the joint, the hydrogen storage material will absorb hydrogen to expand, and the expansion pressure presses the joint to give a tighter connection, so as to achieve the effects of preventing and locking a leak, and compensating a deficiency of tightness due to an accumulated error occurred during the manufacture of the first pipeline and the second pipeline.

### BACKGROUND OF THE INVENTION

1. Field of the Invention

The present invention relates to a method and an apparatus of preventing gas leak in pipeline, and more particularly to a technology that adopts the characteristic of a hydrogen storage material as a medium of the gas pipeline, such that when a gas (such as hydrogen or hydrogen containing gas) in the pipeline leaks, the characteristic of the hydrogen storage material produces a spontaneous reaction to achieve the effect of preventing and locking the gas leak.

2. Background of the Invention

In general, a hydrogen storage material (such as a hydrogen storage alloy) is primarily used for storing hydrogen, improving the efficiency of storing hydrogen, and providing a higher storage density than the storage of high-pressure gas. Compared with the number of hydrogen atoms stored per unit volume, the storage density of a hydrogen storage alloy is approximately six times as much as the hydrogen storage of a hydrogen storage material at 250 atmospheres, and thus its hydrogen storage is over six times of that of the hydrogen storage material.

The storage principle of the hydrogen storage alloy adopts a physical method of dispersing hydrogen atoms into metal lattices, such that when the concentration of hydrogen atoms in the metal lattices increases, a chemical reaction takes place to produce a metal hydride for storing hydrogen, and the metal hydride produced at specific temperature and pressure is decomposed to release hydrogen, and the metal hydride is produced and decomposed repeatedly, and such process constitutes the basic principle for the hydrogen storage alloy to absorb and release hydrogen, and the phase change of the metal hydride produced during the production process generally comprises the following steps:

In Step 1, high pressure hydrogen is dispersed from the surface of the hydrogen storage alloy to the inside, if high pressure hydrogen is applied onto the hydrogen storage alloy. Now, the hydrogen storage alloy absorbs a small quantity of hydrogen, and the hydrogen atoms are solid soluble in the gap of the hydrogen storage alloy to form an α phase by a physical adsorption, and that constitutes the hydrogen containing solid solution. This stage is compliant with the Sievert's Law, which states that the concentration of hydrogen atoms solid soluble at a metal substrate (or a hydrogen storage alloy) is directly proportional to the square root of the applied hydrogen pressure, and the related formula is given below:

C=Kₛ·\sqrt{P}

where, C is the concentration of hydrogen solid soluble at a metal substrate (or a hydrogen storage alloy); Kₛ is a constant; and P is the applied hydrogen pressure.

In Step 2, the α solid solution starts a phase change into a β phase, if the concentration of hydrogen atoms included in the metal lattices is increased, and then the metal hydride starts its formation, and the related formula is given below:

$$\frac{2}{( y - x )} M {H}_{x} + {H}_{2} -> \frac{2}{( y - x )} M {H}_{y} + Q$$

where, MHₓ is for a hydrogen containing solid solution at an early stage; MH_{y} is for a metal hydride converted after absorbing some hydrogen; x is an equilibrium concentration of hydrogen in the solid solution; H₂ is hydrogen provided by the outside; y is the concentration of hydrogen in an alloy hydride; and Q is the reaction energy of the heat discharged during the hydrogen absorption process.

In Step 3, if the hydrogen pressure continues increasing, then the solid solution will be converted into a metal hydride completely, and the hydrogen absorbing platform will disappear, and the environmental pressure will be increased drastically, and this region will become the final stage of hydrogen absorption of the metal hydride.

Since the hydrogen storage principle of the hydrogen storage alloy is to fill hydrogen atoms into the gaps of the alloy lattices, such that the original metal lattices will be expanded and twisted, and the phenomenon and extent of such expansion will have different extents of expansions according to different types of alloys, or the extent of expansion will vary by adding a trace of elements into the same kind of alloy. Therefore, many technical literatures and journals are published, and the measured extents of expansions for the volume of various different types of alloys range from 5% to 43%, which represent the types of alloys, and show that the selection and control of alloys can be applied to pipes for the extent of expansion of the alloy.

However, the prior art can simply use the hydrogen storage material for the hydrogen storage function only, but it does not fully use the characteristic of the hydrogen storage material to extend the scope of its application. Therefore, it is a subject for designers and manufacturers to promote the industrial development and advancement by developing a new technology for preventing gas leaks in high pressure pipelines.

### SUMMARY OF THE INVENTION

In view of the foregoing shortcomings of the prior art that has not fully used the characteristic of the hydrogen storage material for the hydrogen storage function, the inventor of the present invention based on years of experience in the related industry to conduct extensive researches and experiments to overcome the shortcomings of the prior art, and finally invented a method and an apparatus of preventing gas leak in pipeline in accordance with the present invention.

The primary objective of the present invention is to provide a method and an apparatus of preventing gas leak in pipeline, and the method applies a hydrogen storage material at a joint of pipelines of a hydrogen containing gas, such that if there is a leak in the pipeline, the leaked hydrogen containing gas will cause the hydrogen storage material filled in the pipeline to expand, and the expansion force of the hydrogen storage material will squeeze the joint of the pipeline to connect the joint more securely. The characteristic of the hydrogen storage material can solve the leaking problem of pipelines with high pressure hydrogen. In the high pressure environment, a low pressure can provide better hydrogen absorption rate and expansion rate for the hydrogen storage material, and thus the hydrogen storage material can be used for mending a leaking gap at the joint of the pipeline, so as to effectively compensate any leaking gap caused by the accumulated error produced during the manufacture of pipelines adopts washers or O-rings for the connection, and thus the method and apparatus of the present invention are very useful in related industries including gas companies, pipeline manufacturers, and high pressure hydrogen users.

### BRIEF DESCRIPTION OF THE DRAWING

FIG. 1 is a lateral cross-sectional view of a hydrogen storage material being used for absorbing hydrogen leaked from a joint of a first pipeline and a second pipeline in accordance with the present invention; and

FIG. 2 is a lateral cross-sectional view of a hydrogen storage material being used at a joint of a first pipeline and a second pipeline secured by a screw thread in accordance with the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

The invention relates to a method and an apparatus of preventing gas leak in pipeline, and the method makes use of the characteristic of a hydrogen storage material to expand when the hydrogen storage material absorbs hydrogen or hydrogen containing gas, and fills the hydrogen storage material in a joint of a first pipeline and a second pipeline as a medium for the joint, such that when hydrogen or hydrogen containing gas flows in the first pipeline and the second pipeline, the hydrogen storage material will absorb hydrogen to expand to squeeze the joint, and achieve a locking effect for preventing leakages.

The first pipeline and the second pipeline can be stainless steel pipes, copper popes or plastic pipes, and the first pipeline and the second pipeline can be connected by engaging a screw thread, such that a pressure is exerted onto the hydrogen storage material in advance for enhancing the tightness of expansion after the hydrogen is absorbed, so as to achieve the effect of preventing leaks. Further, there is a difference of internal diameters between the first pipeline and the second pipeline.

The hydrogen storage material can be powder, thin film or solid lump.

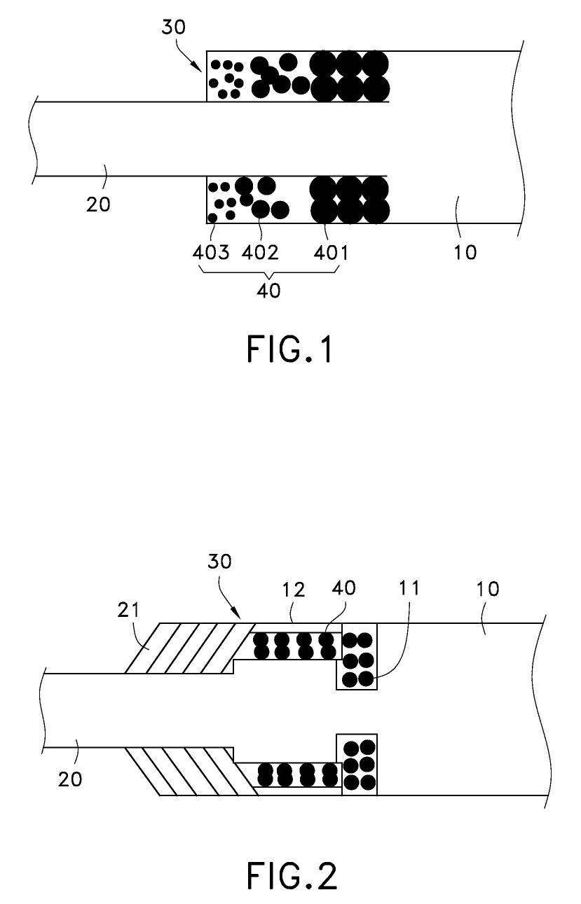

Referring to FIG. 1 for a lateral cross-sectional view of an apparatus of the present invention, a hydrogen storage material 40 is applied into a joint 30 of a first pipeline 10 and a second pipeline 20 for absorbing leaked hydrogen, and the apparatus comprises a first pipeline 10, a second pipeline 20 and a hydrogen storage material 40, wherein the internal diameter of the first pipeline 10 is larger than the internal diameter of the second pipeline 20 (or internal diameter of the second pipeline 20 is larger than the internal diameter of the first pipeline 10), and the hydrogen storage material 40 is filled into the joint 30 of the first pipeline 10 and the second pipeline 20. When hydrogen or hydrogen containing gas flows in the first pipeline 10 and the second pipeline 20, any leaked gas must pass through the filled area of the hydrogen storage material 40 (which is the joint 30 in this case), and the hydrogen storage material 40 will be expanded to different extents according to the time period of the hydrogen storage material 40 being in contact with hydrogen. At the beginning, a front section 401 of the hydrogen storage material absorbs high pressure hydrogen up to 100% saturation, and the extent of expansion in this section is greater than other sections. Thereafter, a middle section 402 of the hydrogen storage material absorbs the remaining hydrogen through the gaps, but the leakage of most leaked gases is reduced since the hydrogen storage material 40 expands to squeeze the joint 30. Therefore, the extent of expansion at the middle section 402 of the hydrogen storage material is smaller that the front section 401, and the gap can be filled to achieve a complete seal. A rear section 403 of the hydrogen storage material serves as an insured filling for capturing the final remaining hydrogen, and the first pipeline 10 and the second pipeline 20 with different internal diameters are squeezed by the expansion of the hydrogen storage material 40 to achieve the effect of preventing and locking a leak.

Referring to FIG. 2 for a lateral cross-sectional view of a hydrogen storage material 40 being used at a joint 30 of a first pipeline 10 and a second pipeline 20 secured by a screw thread 21 in accordance with the present invention, the hydrogen storage material 40 is filled into the joint 30 of the first pipeline 10 and the second pipeline 20, and the first pipeline 10 and the second pipeline 20 can further be connected by a screw thread 21 at the primary connecting force in the joint 30, and a corresponding end coupled to the screw thread 21 includes a retaining platform 11 (such as the interior of the first pipeline 10) for filling the hydrogen storage material 40, and a washer is installed at an external layer of the hydrogen storage material 40, such that if there is a leak, the hydrogen storage material 40 will expand to squeeze the washer 12, and an additional supporting force will be exerted at the joint 30 of the first pipeline 10 and the second pipeline 20 to seal the pipe walls completely and achieve the effect of preventing a high pressure leak.

In summation to the description above, the method and apparatus of the present invention can effectively prevent a continuous gas leak in the first pipeline 10 and the second pipeline 20, so as to achieve the effect of preventing and locking a leak and compensate a deficiency of tightness caused by the accumulated error produced when the first pipeline 10 and the second pipeline 20 are manufactured, and different hydrogen storage materials 40 with different expansion effects for absorbing hydrogen at different temperatures are selected to fit the operating environments from room temperature to high temperature. Obviously, the present invention complies with the requirements of the patent application and is definitely very useful in related industries including gas companies, pipeline manufacturers and high pressure hydrogen users.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of preventing gas leak in pipeline, that makes use of a characteristic of a hydrogen storage material to produce an expansion when the hydrogen storage material is in contact with a hydrogen containing gas, and installs the hydrogen storage material in a joint of a first pipeline and a second pipeline as a medium of the joint, such that when the hydrogen containing gas flows in the first pipeline and second pipeline, the hydrogen storage material will absorb hydrogen to expand and squeeze the joint to achieve a locking effect.

2. The method of preventing gas leak in pipeline as recited in claim 1, wherein the first pipeline and the second pipeline are stainless steel pipes, copper pipes or plastic pipes.

3. The method of preventing gas leak in pipeline as recited in claim 2, wherein the first pipeline and the second pipeline are connected by a screw thread, such that a pressure is exerted to the hydrogen storage material in advance for enhancing the tightness of the expansion after the hydrogen storage material absorbs hydrogen.

4. The method of preventing gas leak in pipeline as recited in claim 3, wherein the first pipeline and the second pipeline have a difference between their internal diameters.

5. The method of preventing gas leak in pipeline as recited in claim 3, wherein the hydrogen storage material is a powder, a thin film, or a solid lump.

6. An apparatus of preventing gas leak in pipeline, comprising a first pipeline and a second pipeline connected to the first pipeline, characterized in that a hydrogen storage material is disposed in at a joint of the first pipeline and the second pipeline, the hydrogen storage material will produce expansions to different extents according to different extents of time for hydrogen to be in contact with the first pipeline and the second pipeline.

7. The apparatus of preventing gas leak in pipeline as recited in claim 6, further comprising a screw thread for a primary jointing force in the joint for connecting the first pipeline and the second pipeline, and a corresponding end connected with the screw thread includes a retaining platform for filling the hydrogen storage material, and a washer installed onto an external layer of the screw thread.

8. The apparatus of preventing gas leak in pipeline as recited in claim 7, wherein the first pipeline and the second pipeline have a difference of their internal diameters.
